(19) United States
(12) Patent Application Publication
(10) Pub. No.: US 2024/0306116 A1
(43) Pub. Date: Sep. 12, 2024

(54) INFORMATION SENDING METHOD AND APPARATUS, AND RELATIONSHIP DETERMINATION METHOD AND APPARATUS

(71) Applicant: Beijing Xiaomi Mobile Software Co., Ltd., Beijing (CN)

(72) Inventor: Xiaolong LI, Beijing (CN)

(21) Appl. No.: 18/258,538

(22) PCT Filed: Dec. 21, 2021
(86) PCT No.: PCT/CN2020/137994

§ 371 Date: Jun. 20, 2023

(51) Int. Cl. H04W 64/00

(52) U.S. Cl. CPC H04W 64/00

(57) ABSTRACT

An information sending method is applied to a first terminal, and includes: sending a quality of service information for determining a relative spatial relationship quality of service information is configured to determine the relative spatial relationship with the second terminal.

### BACKGROUND

At present, in a 5G new radio (NR), user equipment may be requested to be positioned by a network, or the user equipment may be requested to be positioned by themselves.

### SUMMARY

According to a first aspect of an example of the disclosure, an information sending method is provided, performed by a first terminal, and including:

sending a quality of service information for determining the relative spatial relationship to a second terminal, the quality of service information is configured to determine the relative spatial relationship with the second terminal.

According to a second aspect of an example of the disclosure, a relationship determination method is provided, performed by a second terminal, and including:
receiving quality of service information, sent by a first terminal, for determining a relative spatial relationship; and
determining the relative spatial relationship according to the quality of service information.

According to a third aspect of an example of the disclosure, an electronic device is provided, including:
a processor; and
a memory for storing executable instructions of the processor, where
the processor is configured to execute the above information sending method and/or the above relationship determination method.

According to a fourth aspect of an example of the disclosure, a computer-readable storage medium is provided, storing a computer program instruction. The program instruction, when executed by a processor, implements the steps of the above information sending method and/or the above relationship determination method.

### BRIEF DESCRIPTION OF THE DRAWINGS

In order to illustrate technical solutions in examples of the disclosure more clearly, accompanying drawings needing to be used in description of the examples will be introduced below briefly. Apparently, the accompanying drawings in the description below are merely some examples of the disclosure, those ordinarily skilled in the art can further obtain other accompanying drawings according to these accompanying drawings without creative effort.

FIG. 1 is a schematic flow diagram of an information sending method shown according to an example of the disclosure.

FIG. 2 is a schematic flow diagram of another information sending method shown according to an example of the disclosure.

FIG. 3 is a schematic flow diagram of yet another information sending method shown according to an example of the disclosure.

FIG. 4 is a schematic flow diagram of yet another information sending method shown according to an example of the disclosure.

FIG. 5A is a schematic flow diagram of yet another information sending method shown according to an example of the disclosure.

FIG. 5B is another schematic flow diagram of sending quality of service information during establishing a sidelink shown according to an example of the disclosure.

FIG. 6 is a schematic flow diagram of yet another information sending method shown according to an example of the disclosure.

FIG. 7 is a schematic flow diagram of a relationship determination method shown according to an example of the disclosure.

FIG. 8 is a schematic flow diagram of another relationship determination method shown according to an example of the disclosure.

FIG. 9 is a schematic flow diagram of yet another relationship determination method shown according to an example of the disclosure.

FIG. 10 is a schematic flow diagram of yet another relationship determination method shown according to an example of the disclosure.

FIG. 11 is a schematic flow diagram of yet another relationship determination method shown according to an example of the disclosure.

FIG. 12 is a schematic flow diagram of yet another relationship determination method shown according to an example of the disclosure.

FIG. 13 is a schematic flow diagram of yet another relationship determination method shown according to an example of the disclosure.

FIG. 14 is a schematic block diagram of an information sending apparatus shown according to an example of the disclosure.

FIG. 15 is a schematic block diagram of another information sending apparatus shown according to an example of the disclosure.

FIG. 16 is a schematic block diagram of yet another information sending apparatus shown according to an example of the disclosure.

FIG. 17 is a schematic block diagram of yet another information sending apparatus shown according to an example of the disclosure.

FIG. 18 is a schematic block diagram of a relationship determination apparatus shown according to an example of the disclosure.

FIG. 19 is a schematic block diagram of another relationship determination apparatus shown according to an example of the disclosure.

FIG. 20 is a schematic block diagram of yet another relationship determination apparatus shown according to an example of the disclosure.

FIG. 21 is a schematic block diagram of yet another relationship determination apparatus shown according to an example of the disclosure.

FIG. 22 is a schematic block diagram of yet another relationship determination apparatus shown according to an example of the disclosure.

FIG. 23 is a schematic block diagram of an apparatus for information sending and/or relationship determination shown according to an example of the disclosure.

### DETAILED DESCRIPTION

The technical solutions in the examples of the disclosure will be described below clearly and completely with reference to the accompanying drawings in the examples of the disclosure. Apparently, the described examples are merely some rather than all of the examples of the disclosure. On the basis of the examples in the disclosure, all other examples obtained by those ordinarily skilled in the art without creative effort fall within the protection scope of the disclosure.

The disclosure relates to the technical field of communications, in particular to an information sending method, a relationship determination method, an information sending apparatus, a relationship determination apparatus, an electronic device and a computer-readable storage medium.

At present, in a 5G new radio (NR), there is no user equipment that can position other user equipment yet.

In view of this, examples of the disclosure provide an information sending method, a relationship determination method, an information sending apparatus, a relationship determination apparatus, an electronic device and a computer-readable storage medium, so as to solve technical problems in the related art.

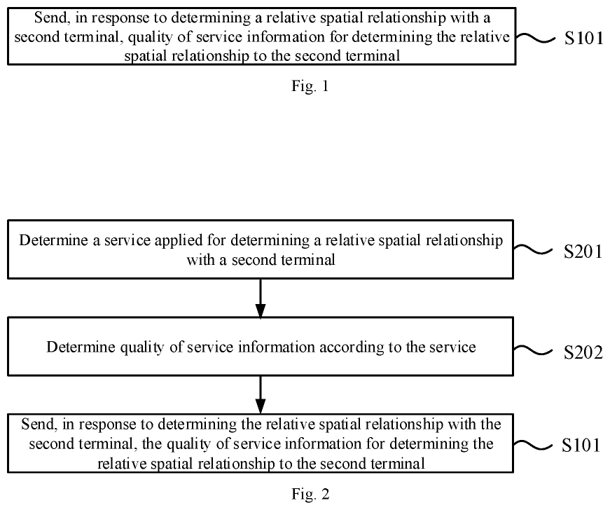

FIG. 1 is a schematic flow diagram of an information sending method shown according to an example of the disclosure. The information sending method shown in this example may be applicable to a first terminal, and the first terminal includes, but is not limited to, electronic devices such as a mobile phone, a tablet computer, a wearable device, a sensor and an IoT device. The first terminal may communicate with a base station as user equipment, and the base station includes, but is not limited to, a 4G base station, a 5G base station, and a 6G base station.

The first terminal may further communicate with other terminals, such as a second terminal, where the first terminal may establish a sidelink (also known as a bylink or a side link) with the second terminal. An interface may be a PC5 interface, and then the first terminal communicates with the second terminal through a sidelink. The first terminal and the second terminal need to communicate according to specific quality of service (QOS), such as a transmitting signaling and data, and relevant parameters of the QoS may be used for a QoS flow.

In one example, the first terminal and the second terminal may determine a relative spatial relationship. For example, as an initiating terminal for determining the relative spatial relationship, the first terminal may determine a location, distance, angle, etc. of the second terminal relative to the first terminal, and the second terminal may also determine a location, distance, angle, etc. of the first terminal relative to the second terminal. A process of determining the relative spatial relationship may be referred to as relative positioning, ranging or sensing, a ranging based or sensing based service, and sidelink positioning.

A situation that the first terminal determines the location of the second terminal relative to the first terminal is taken as an example.

The first terminal may determine a relative angle of the second terminal relative to the first terminal. The relative angle includes, but is not limited to, an angle of arrival (AOA) and an angle of departure (AOD). AOA represents an included angle between an antenna of a signal receiver of the first terminal and a reference signal received from the second terminal, and AOD represents an included angle between an antenna of a signal transmitter of the first terminal and a reference signal transmitted to the second terminal.

The first terminal may determine a relative distance of the second terminal relative to the first terminal. For example, the relative distance is determined according to reception time of receiving the reference signal from the second terminal, sending time of the reference signal, and a transmission speed of the reference signal.

Then the location of the second terminal relative to the first terminal may be determined according to the relative angle and a relative speed.

During determining the relative spatial relationship, the first terminal and the second terminals may receive and send the signal through a sidelink.

However, during determination of the relative spatial relationship between the terminals, based on a specific scenario, there are specific quality of service requirements for the determined relative spatial relationship. However, the requirements for the quality of service when determining the relative spatial relationship by the terminals may differ from requirements for the quality of service in other communication processes (such as the transmission signaling and data) between the terminals, so even if the quality of service needed in the communication process is determined between the terminals after establishing the sidelink, the quality of service may not meet the quality of service needed for determining the relative spatial relationship between the terminals.

As shown in FIG. 1, the information sending method may include the following steps.

In step S101, sending a quality of service information for determining the relative spatial relationship to a second terminal, the quality of service information is configured to determine the relative spatial relationship with the second terminal.

In one example, the relative spatial relationship includes at least one of the followings:
a relative location, a relative distance, a relative angle and a relative speed.

In one example, when needing to determine the relative spatial relationship to the second terminal, a first terminal may send the quality of service information for determining the relative spatial relationship to the second terminal. Accordingly, the second terminal may be caused to determine the relative spatial relationship with the first terminal according to the received quality of service information, for example, determine a configuration of sending a reference signal to the first terminal according to the quality of service information, and/or measure the reference signal sent by the first terminal according to the quality of service information, such that the relative spatial relationship determined by the first terminal meets needed quality of service.

In one example, the first terminal may send the quality of service information to the second terminal merely when needing to determine a specified relative spatial relationship to the second terminal. For example, the quality of service information may be sent to the second terminal merely when the relative location needs to be determined. When the relative speed needs to be determined, the quality of service information does not need to be sent to the second terminal, where the specified relative spatial relationship may be set as needed.

In one example, the quality of service information includes at least one of the followings:
precision information of the relative spatial relationship;
first response time for sending a reference signal for determining the relative spatial relationship to the first terminal;
second response time for sending a result information of the relative spatial relationship to the first terminal; and
a distance upper limit for determining the relative spatial relationship.

In one example, the quality of service information may include the precision information of the relative spatial relationship. Taking determination of the relative distance as an example, the second terminal may determine the distance of the first terminal relative to the second terminal, and then send the determined distance as result information to the first terminal. During determination of the distance of the first terminal relative to the second terminal, the distance needs to be determined according to the precision information. For example, the precision information is 1 cm, so precision of the determined distance needs to reach 1 cm, and the second terminal needs to perform relevant measurement on the reference signal sent by the first terminal according to the requirements of the precision information.

In one example, the quality of service information may include the first response time for sending, by the second terminal, the reference signal for determining the relative spatial relationship to the first terminal. Taking determination of the relative distance as an example, in order to enable the first terminal to determine the location of the second terminal relative to the first terminal, the second terminal may send the reference signal to the first terminal. For example, the first response time is 10 ms, after receiving a request from the first terminal to determine the relative location, the second terminal needs to send the reference signal to the first terminal within 10 ms, so that the first terminal may determine the relative position timely.

In one example, the quality of service information may include the second response time for sending, by the second terminal, the result information for determining the relative spatial relationship to the first terminal. Taking determination of the relative distance as an example, the second terminal may determine the location of the second terminal relative to the first terminal, and then send the determined location as the result information to the first terminal. For example, the second response time is 100 ms, after receiving the request from the first terminal to determine the relative location, the second terminal needs to send the determined location to the first terminal within 100 ms, so that the first terminal acquires the location determined by the second terminal timely.

In one example, the quality of service information may include the distance upper limit for determining the relative spatial relationship. The distance upper limit may be set as needed or estimated by the first terminal, and may be understood as a maximum possible distance between the first terminal and the second terminal when the first terminal determines the relative spatial relationship to the second terminal. In the process of determining the relative spatial relationship, the second terminal needs to send the reference signal to the first terminal. In order to cause the sent signal to be well received by the first terminal, the second terminal may determine transmission power of the reference signal according to the distance upper limit. For example, the higher the distance upper limit, the greater the transmission power.

According to the examples of the disclosure, when needing to determine the relative spatial relationship with the second terminal, the first terminal may send the quality of service information for determining the relative spatial relationship to the second terminal. Accordingly, the second terminal may be caused to determine the relative spatial relationship to the first terminal according to the received quality of service information, such that the relative spatial relationship determined by the first terminal meets needed quality of service.

FIG. 2 is a schematic flow diagram of another information sending method shown according to an example of the disclosure. As shown in FIG. 2, in some examples of the disclosure, the method further includes:
in step S201, a service applied for determining the relative spatial relationship to the second terminal is determined; and
in step S202, the quality of service information is determined according to the service.

In one example, in general, the relative spatial relationship determined by the first terminal with the second terminal needs to be applied to a specific communication service, such as multimedia sharing, object seeking, and smart home control. For different services, the quality of service needed by the service may vary, so the quality of service information may be determined according to the service.

For example, a service A needs a lower delay, in a case that the relative position needs to be used, the first terminal needs to quickly determine the relative position, the first response time determined by the first terminal may be smaller, so that the second terminal sends the reference signal to the first terminal as soon as possible for allowing the first terminal to determine the relative position as soon as possible, thus meeting requirements of the service A for low delay.

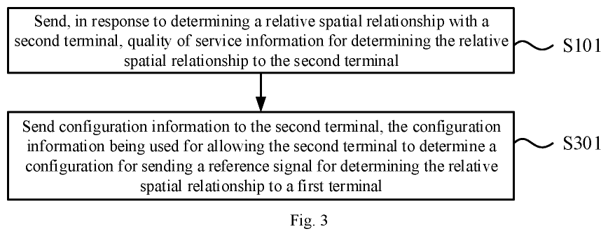

FIG. 3 is a schematic flow diagram of yet another information sending method shown according to an example of the disclosure. As shown in FIG. 3, in some examples of the disclosure, the method further includes:

in step S301, configuration information is sent to the second terminal, the configuration information is configured to allow the second terminal to determine a configuration for sending a reference signal for determining the relative spatial relationship to the first terminal.

In one example, the configuration information includes at least one of the followings:
bandwidth information, period information, time-domain density information, and frequency-domain density information.

In one example, the second terminal needs to send the reference signal to the first terminal according to certain configurations. In this example, the first terminal may send the configuration information to the second terminal for allowing the second terminal to determine the configuration for sending the reference signal to the first terminal, that is, the first terminal sends the configuration information to the second terminal for reference by the second terminal. The second terminal may determine the configuration for sending the reference signal according to the configuration information, and the second terminal may also determine the configuration for sending the reference signals according to its own needs, rather than according to the configuration information.

For example, the configuration information includes the bandwidth information, which may be used by the second terminal to determine a bandwidth for sending the reference signal. For example, the bandwidth information is 10M, a bandwidth of a sidelink for communication between the first terminal and the second terminal is 20M, and then the second terminal may select a 10M bandwidth from the 20M bandwidth to send the reference signal. Certainly, as mentioned earlier, the second terminal may also determine the configuration for sending the reference signal without relying on the configuration information. For example, the second terminal itself needs a 15M bandwidth for communication, the second terminal may select the 15M bandwidth from the 20M bandwidth to send the reference signal.

For example, the configuration information includes the period information, which may be used by the second terminal to determine a period of sending the reference signal. For example, the configuration information includes the time-domain density information, which may be used by the second terminal to determine a time-domain density for sending the reference signal. For example, the configuration information includes the frequency-domain density information, which may be used by the second terminal to determine a frequency-domain density for sending the reference signal.

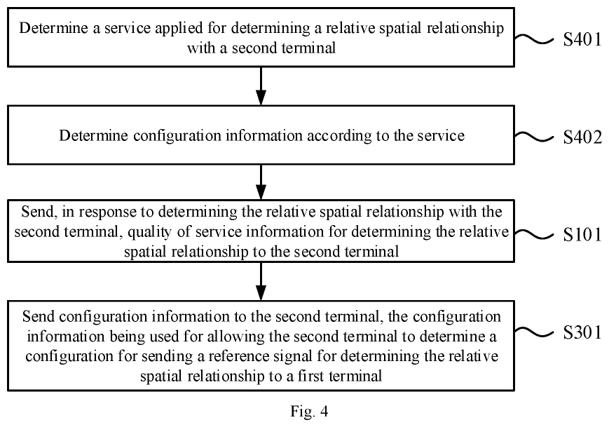

FIG. 4 is a schematic flow diagram of yet another information sending method shown according to an example of the disclosure. As shown in FIG. 4, in some examples of the disclosure, the method further includes:
in step S401, a service applied for determining the relative spatial relationship to the second terminal is determined; and
in step S402, the configuration information is determined according to the service.

In one example, in general, the relative spatial relationship determined by the first terminal with the second terminal needs to be applied to a specific communication service, such as multimedia sharing, object seeking, and smart home control. For different services, the communication configuration needed by the service may vary, so the configuration information may be determined according to the service.

For example, a service A needs to acquire the relative position frequently, the first terminal needs to frequently determine the relative position, and then a determination period may be small, so that the second terminal may send the reference signal to the first terminal frequently for allowing the first terminal to frequently determine the relative position, thus meeting frequency requirements of the service A for acquiring the relative position.

For example, a service B needs to have high precision in the acquired relative position, the first terminal needs to acquire the reference signals in more time domains and frequency domains, and the it is determined that the time-domain density and the frequency-domain density in the configuration information may be relatively large, so that the second terminal may send the reference signal to the first terminal with the large time-domain density and frequency-domain density for allowing the first terminal to determine the relative position relatively accurately, thus meeting precision requirements of the service B for acquiring the relative position.

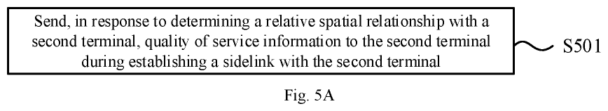

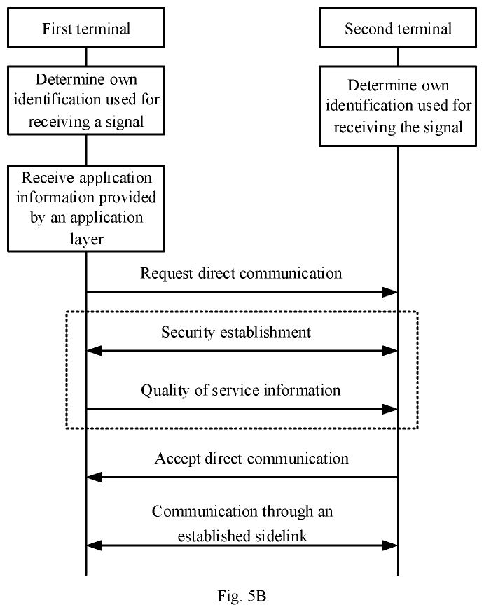

FIG. 5A is a schematic flow diagram of yet another information sending method shown according to an example of the disclosure. As shown in FIG. 5A, in some examples of the disclosure, the sending the quality of service information for determining the relative spatial relationship to the second terminal includes:
in step S501, the quality of service information is sent to the second terminal during establishing a sidelink with the second terminal.

In one example, the first terminal may communicate with the second terminal through a sidelink. In the process of establishing the sidelink with the second terminal, the first terminal may send the quality of service information to the second terminal.

FIG. 5B is another schematic flow diagram of sending quality of service information during establishing a sidelink shown according to an example of the disclosure.

In one example, the first terminal and the second terminal may determine destination identification (such as Layer-2 ID) for reception according to application information. If a direct communication request sent by the first terminal contains the destination identification, the second terminal may receive the signal sent by the first terminal and perform parsing and recognition. However, if the direct communication request sent by the first terminal does not contain the destination identification, even if the second terminal receives the signal sent by the first terminal, the second terminal will not perform parsing and recognition.

Next, the first terminal, as an initiator of establishing the sidelink, may receive application information provided by its own application layer and then send the direct communication request to the second terminal in modes such as broadcasting, unicast, and multicast, to request the establishment of the sidelink with the second terminal.

Next, the first terminal and the second terminal may undergo a security establishment process, where the quality of service information may be sent to the second terminal in this process.

After completing the security establishment, the second terminal may send a direct communication accept to the first terminal in a mode such as unicast. The first terminal may determine the completion of the establishment of the sidelink.

Next, the first terminal may communicate with the second terminal through the established sidelink, for example, at an access layer of the sidelink, and complete the process of determining the relative spatial relationship by the first terminal and the second terminal according to the quality of service information.

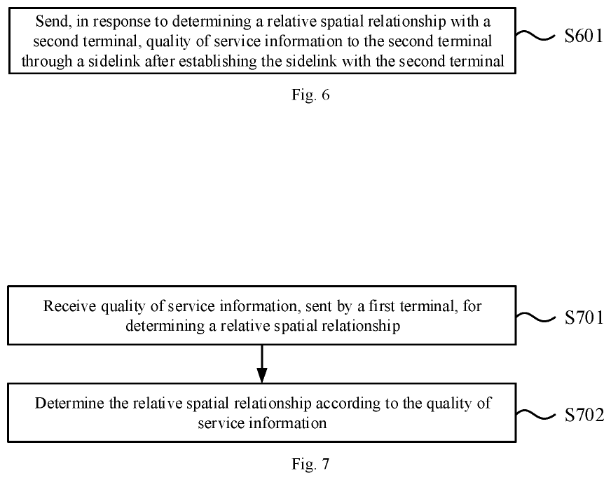

FIG. 6 is a schematic flow diagram of yet another information sending method shown according to an example of the disclosure. As shown in FIG. 6, in some examples of the disclosure, the sending the quality of service information for determining the relative spatial relationship to the second terminal includes:
in step S601, the quality of service information is sent to the second terminal through a sidelink after establishing the sidelink with the second terminal.

In one example, the first terminal may communicate with the second terminal through a sidelink. After establishing the sidelink with the second terminal, the first terminal may send the quality of service information to the second terminal through the established sidelink, for example, by carrying the quality of service information through a PC5 radio resource control (RRC) message to be sent to the second terminal.

FIG. 7 is a schematic flow diagram of a relationship determination method shown according to an example of the disclosure. The relationship determination method shown in this example may be applicable to a second terminal, and the second terminal includes, but is not limited to, electronic devices such as a mobile phone, a tablet computer, a wearable device, a sensor and an IoT device. The second terminal may communicate with a base station as user equipment, and the base station includes, but is not limited to, a 4G base station, a 5G base station, and a 6G base station.

The second terminal may further communicate with other terminals, such as a first terminal, where the second terminal may establish a sidelink with the first terminal. An interface may be a PC5 interface, and then the second terminal communicates with the first terminal through the sidelink.

In one example, the first terminal and the second terminal may determine a relative spatial relationship. For example, as an initiating terminal for determining the relative spatial relationship, the first terminal may determine a location, distance, angle, etc. of the second terminal relative to the first terminal, and the second terminal may also determine a location, distance, angle, etc. of the first terminal relative to the second terminal. A process of determining the relative spatial relationship may be referred to as relative positioning, ranging or sensing, a ranging based or sensing based service, and sidelink positioning.

A situation that the first terminal determines the location of the second terminal relative to the first terminal is taken as an example.

The first terminal may determine a relative angle of the second terminal relative to the first terminal. The relative angle includes, but is not limited to, an angle of arrival and an angle of departure. AOA represents an included angle between an antenna of a signal receiver of the first terminal and a reference signal received from the second terminal, and AOD represents an included angle between an antenna of a signal transmitter of the first terminal and a reference signal transmitted to the second terminal.

The first terminal may determine a relative distance of the second terminal relative to the first terminal, for example, the second terminal sends a reference signal to the first terminal, and the first terminal determines the relative distance according to reception time of receiving the reference signal, sending time of the reference signal, and a transmission speed of the reference signal.

Then the location of the second terminal relative to the first terminal may be determined according to the relative angle and a relative speed.

During determining the relative spatial relationship, the first terminal and the second terminals may receive and send the signal through a sidelink.

However, during determination of the relative spatial relationship between the terminals, based on a specific scenario, there are specific quality of service requirements for the determined relative spatial relationship. However, the requirements for the quality of service when determining the relative spatial relationship by the terminals may differ from requirements for the quality of service in other communication processes (such as the transmission signaling and data) between the terminals, so even if the quality of service needed in the communication process is determined between the terminals after establishing the sidelink, the quality of service may not meet the quality of service needed for determining the relative spatial relationship between the terminals.

As shown in FIG. 7, the relationship determination method may include the following steps:
in step S701, quality of service information, sent by a first terminal, for determining a relative spatial relationship is received; and
in step S702, the relative spatial relationship is determined according to the quality of service information.

In one example, the relative spatial relationship includes at least one of the followings:
a relative location, a relative distance and a relative angle.

In one example, when needing to determine the relative spatial relationship to the second terminal, the first terminal may send the quality of service information for determining the relative spatial relationship to the second terminal. Accordingly, the second terminal may determine the relative spatial relationship with the first terminal according to the received quality of service information, for example, determine a configuration of sending a reference signal to the first terminal according to the quality of service information, and/or measure the reference signal sent by the first terminal according to the quality of service information, such that the relative spatial relationship determined by the first terminal meets needed quality of service.

In one example, the quality of service information includes at least one of the followings:
precision information of the relative spatial relationship;
first response time for sending a reference signal for determining the relative spatial relationship to the first terminal;
second response time for sending a result information of the relative spatial relationship to the first terminal; and
a distance upper limit for determining the relative spatial relationship.

In one example, the quality of service information may include the precision information of the relative spatial relationship. Taking determination of the relative distance as an example, the second terminal may determine the distance of the first terminal relative to the second terminal, and then send the determined distance as result information to the first terminal. During determination of the distance of the first terminal relative to the second terminal, the distance needs to be determined according to the precision information. For example, the precision information is 1 cm, so precision of the determined distance needs to reach 1 cm, and the second terminal needs to perform relevant measurement on the reference signal sent by the first terminal according to the requirements of the precision information.

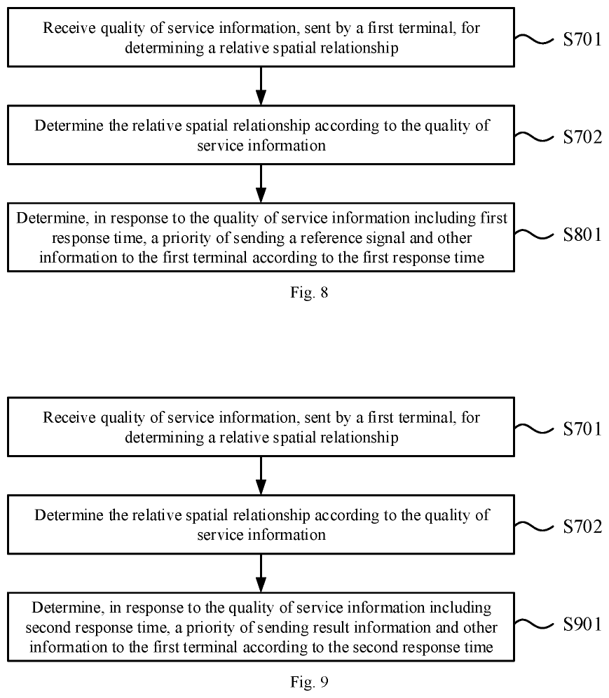

FIG. 8 is a schematic flow diagram of another relationship determination method shown according to an example of the disclosure. As shown in FIG. 8, in some examples of the disclosure, the method further includes:
in step S801, in response to the quality of service information including the first response time, a priority of sending the reference signal and other information to the first terminal is determined according to the first response time.

In one example, the quality of service information may include the first response time for sending, by the second terminal, the reference signal for determining the relative spatial relationship to the first terminal. Taking determination of the relative distance as an example, in order to enable the first terminal to determine the location of the second terminal relative to the first terminal, the second terminal may send the reference signal to the first terminal. For example, the first response time is 10 ms, after receiving a request from the first terminal to determine the relative location, the second terminal needs to send the reference signal to the first terminal within 10 ms, so that the first terminal may determine the relative position timely.

However, when the second terminal needs to send the reference signal, there may be other information that needs to be sent. Hence, the second terminal may determine priorities of the reference signal and other information.

In one example, in a case that the priority of the reference signal is high, the reference signal may be sent first. In a case that the priority of other information is high, the other information may be sent first and then the reference signal is sent.

In one example, when both the reference signal and other information need to be sent, the second terminal may set a higher priority for the reference signal to ensure sending the reference signal in priority.

FIG. 9 is a schematic flow diagram of yet another relationship determination method shown according to an example of the disclosure. As shown in FIG. 9, in some examples of the disclosure, the method further includes:

in step S901, in response to the quality of service information including the second response time, a priority of sending the result information and other information to the first terminal is determined according to the second response time.

In one example, the quality of service information may include the second response time for sending, by the second terminal, the result information of the relative spatial relationship to the first terminal. Taking determination of the relative distance as an example, the second terminal may determine the location of the second terminal relative to the first terminal, and then send the determined location as the result information to the first terminal. For example, the second response time is 100 ms, after receiving the request from the first terminal to determine the relative location, the second terminal needs to send the determined location to the first terminal within 100 ms, so that the first terminal acquires the location determined by the second terminal timely.

However, when the second terminal needs to send the result information, there may be other information that needs to be sent. Hence, the second terminal may determine priorities of the result information and other information.

In one example, in a case that the priority of the result information is high, the reference signal may be sent first. In a case that the priority of other information is high, the other information may be sent first and then the result information is sent.

In one example, when both the result information and other information need to be sent, the second terminal may set a higher priority for the result information to ensure sending the result information in priority.

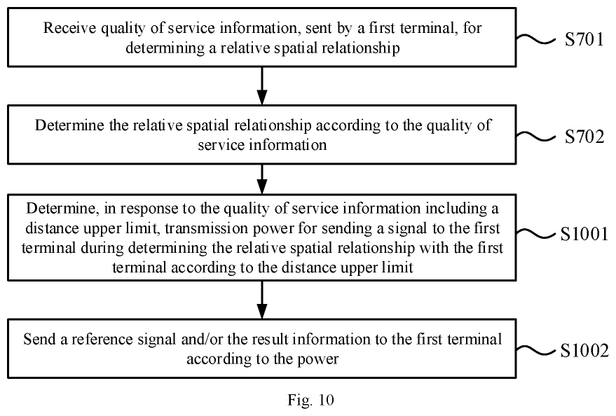

FIG. 10 is a schematic flow diagram of yet another relationship determination method shown according to an example of the disclosure. As shown in FIG. 10, in some examples of the disclosure, the method further includes:

in step S1001, in response to the quality of service information including the distance upper limit, transmission power for sending the signal to the first terminal during determining the relative spatial relationship to the first terminal is determined according to the distance upper limit; and

in step S1002, the reference signal and/or the result information are/is sent to the first terminal according to the transmission power.

In one example, the quality of service information may include the distance upper limit for determining the relative spatial relationship. The distance upper limit may be set as needed or estimated by the first terminal, and may be understood as a maximum possible distance between the first terminal and the second terminal when the first terminal determines the relative spatial relationship to the second terminal.

In the process of determining the relative spatial relationship, the second terminal needs to send the reference signal to the first terminal. In order to cause the sent signal to be well received by the first terminal, the second terminal may determine transmission power of the reference signal according to the distance upper limit. For example, the higher the distance upper limit, the greater the transmission power, and then the reference signal and/or the result information are/is sent to the first terminal according to the transmission power.

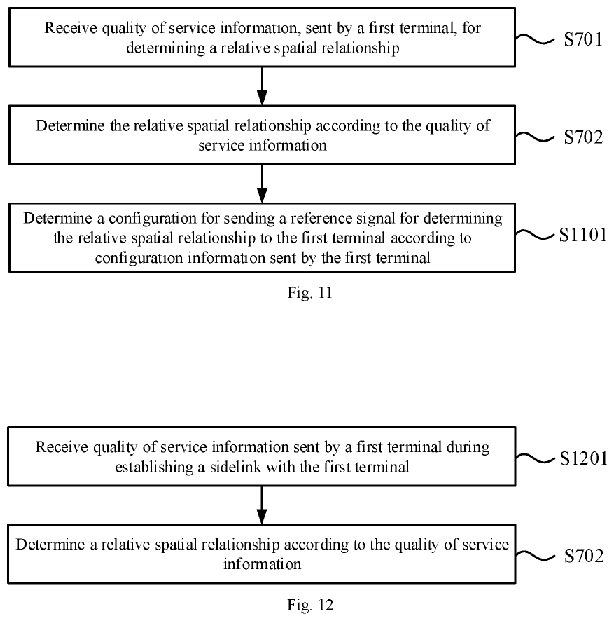

FIG. 11 is a schematic flow diagram of yet another relationship determination method shown according to an example of the disclosure. As shown in FIG. 11, in some examples of the disclosure, the method further includes:

in step S1101, a configuration for sending a reference signal for determining the relative spatial relationship to the first terminal is determined according to the configuration information sent by the first terminal.

In one example, the configuration information includes at least one of the followings:
bandwidth information, period information, time-domain density information, and frequency-domain density information.

In one example, the second terminal needs to send the reference signal to the first terminal according to certain configurations. In this example, the first terminal may send the configuration information to the second terminal for allowing the second terminal to determine the configuration for sending the reference signal to the first terminal, that is, the first terminal sends the configuration information to the second terminal for reference by the second terminal. The second terminal may determine the configuration for sending the reference signal according to the configuration information, and the second terminal may also determine the configuration for sending the reference signals according to its own needs, rather than according to the configuration information.

For example, the configuration information includes the bandwidth information, which may be used by the second terminal to determine a bandwidth for sending the reference signal. For example, the bandwidth information is 10M, a bandwidth of a sidelink for communication between the first terminal and the second terminal is 20M, and then the second terminal may select a 10M bandwidth from the 20M bandwidth to send the reference signal. Certainly, as mentioned earlier, the second terminal may also determine the configuration for sending the reference signal without relying on the configuration information. For example, the second terminal itself needs a 15M bandwidth for communication, the second terminal may select the 15M bandwidth from the 20M bandwidth to send the reference signal.

For example, the configuration information includes the period information, which may be used by the second terminal to determine a period of sending the reference signal. For example, the configuration information includes the time-domain density information, which may be used by the second terminal to determine a time-domain density for sending the reference signal. For example, the configuration information includes the frequency-domain density information, which may be used by the second terminal to determine a frequency-domain density for sending the reference signal.

FIG. 12 is a schematic flow diagram of yet another relationship determination method shown according to an example of the disclosure. As shown in FIG. 12, in some examples of the disclosure, the receiving quality of service information, sent by the first terminal, for determining the relative spatial relationship includes:
in step S1201, the quality of service information sent by the first terminal is received during establishing a sidelink with the first terminal.

In one example, the first terminal may communicate with the second terminal through a sidelink. In the process of establishing the sidelink with the second terminal, the first terminal may send the quality of service information to the second terminal. For example, in the process of security establishment of the first terminal and the second terminal, the quality of service information is sent to the second terminal.

FIG. 13 is a schematic flow diagram of yet another relationship determination method shown according to an example of the disclosure. As shown in FIG. 13, in some examples of the disclosure, the sending the quality of service information for determining the relative spatial relationship to the second terminal includes:
in step S1301, the quality of service information sent by the first terminal is received through a sidelink after establishing the sidelink with the first terminal.

In one example, the first terminal may communicate with the second terminal through a sidelink. After establishing the sidelink with the second terminal, the first terminal may send the quality of service information to the second terminal through the established sidelink, for example, by carrying the quality of service information through a PC5 radio resource control (RRC) message to be sent to the second terminal.

Corresponding to the examples of the aforementioned information sending method and the relationship determination method, the disclosure further provides examples of an information sending apparatus and a relationship determination apparatus.

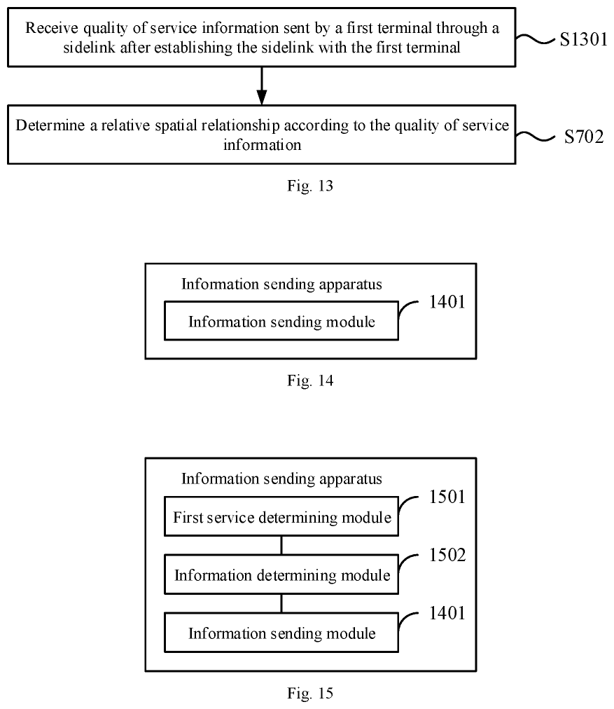

FIG. 14 is a schematic block diagram of an information sending apparatus shown according to an example of the disclosure. The information sending apparatus shown in this example may be applicable to a first terminal, and the first terminal includes, but is not limited to, electronic devices such as a mobile phone, a tablet computer, a wearable device, a sensor and an IoT device. The first terminal may communicate with a base station as user equipment, and the base station includes, but is not limited to, a 4G base station, a 5G base station, and a 6G base station.

The first terminal may further communicate with other terminals, such as a second terminal, where the first terminal may establish a sidelink with the second terminal. An interface may be a PC5 interface, and then the first terminal communicates with the second terminal through a sidelink.

As shown in FIG. 14, the apparatus includes:
an information sending module 1401, configured to send a quality of service information for determining the relative spatial relationship to a second terminal, the quality of service information is configured to determine the relative spatial relationship with the second terminal.

In one example, the relative spatial relationship includes at least one of the followings:
a relative location, a relative distance and a relative angle.

In one example, the quality of service information includes at least one of the followings:
precision information of the relative spatial relationship;
first response time for sending a reference signal for determining the relative spatial relationship to the first terminal;
second response time for sending a result information of the relative spatial relationship to the first terminal; and
a distance upper limit for determining the relative spatial relationship.

FIG. 15 is a schematic block diagram of another information sending apparatus shown according to an example of the disclosure. As shown in FIG. 15, in some examples of the disclosure, the apparatus further includes:
a first service determining module 1501, configured to determine a service applied for determining the relative spatial relationship to the second terminal; and
an information determining module 1502, configured to determine the quality of service information according to the service.

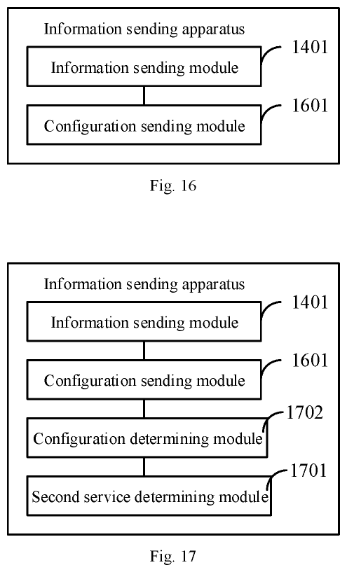

FIG. 16 is a schematic block diagram of yet another information sending apparatus shown according to an example of the disclosure. As shown in FIG. 16, in some examples of the disclosure, the apparatus further includes:

a configuration sending module 1601, configured to send configuration information to the second terminal, the configuration information is configured to allow the second terminal to determine a configuration for sending a reference signal for determining the relative spatial relationship to the first terminal.
In one example, the configuration information includes at least one of the followings:
bandwidth information, period information, time-domain density information, and frequency-domain density information.

FIG. 17 is a schematic block diagram of yet another information sending apparatus shown according to an example of the disclosure. As shown in FIG. 17, in some examples of the disclosure, the apparatus further includes:
a second service determining module 1701, configured to determine a service applied for determining the relative spatial relationship to the second terminal; and
a configuration determining module 1702, configured to determine the configuration information according to the service.

In one example, the information sending module is configured to send the quality of service information to the second terminal during establishing a sidelink with the second terminal.

In one example, the information sending module is configured to send the quality of service information to the second terminal through a sidelink after establishing the sidelink with the second terminal.

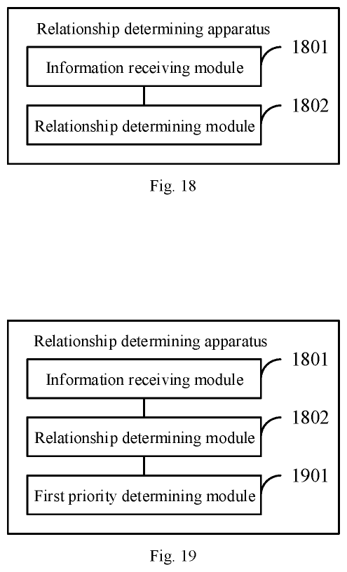

FIG. 18 is a schematic block diagram of a relationship determination apparatus shown according to an example of the disclosure. The relationship determination apparatus shown in this example may be applicable to a second terminal, and the second terminal includes, but is not limited to, electronic devices such as a mobile phone, a tablet computer, a wearable device, a sensor and an IoT device. The second terminal may communicate with a base station as user equipment, and the base station includes, but is not limited to, a 4G base station, a 5G base station, and a 6G base station.

The second terminal may further communicate with other terminals, such as a first terminal, where the second terminal may establish a sidelink with the first terminal. An interface may be a PC5 interface, and then the second terminal communicates with the first terminal through a sidelink.

As shown in FIG. 18, the apparatus includes:
an information receiving module 1801, configured to receive quality of service information, sent by a first terminal, for determining a relative spatial relationship; and
a relationship determining module 1802, configured to determine the relative spatial relationship according to the quality of service information.

In one example, the relative spatial relationship includes at least one of the followings:
a relative location, a relative distance and a relative angle.

In one example, the quality of service information includes at least one of the followings:
precision information of the relative spatial relationship;
first response time for sending a reference signal for determining the relative spatial relationship to the first terminal;
second response time for sending a result information of the relative spatial relationship to the first terminal; and
a distance upper limit for determining the relative spatial relationship.

FIG. 19 is a schematic block diagram of another relationship determination apparatus shown according to an example of the disclosure. As shown in FIG. 19, in some examples of the disclosure, the apparatus further includes:
a first priority determining module 1901, configured to determine, in response to the quality of service information including the first response time, a priority of sending the reference signal and other information to the first terminal according to the first response time.

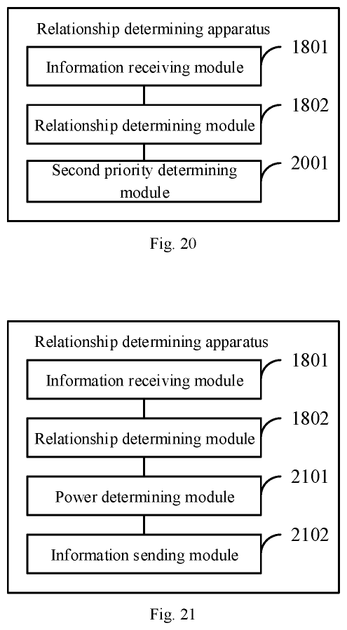

FIG. 20 is a schematic block diagram of yet another relationship determination apparatus shown according to an example of the disclosure. As shown in FIG. 20, in some examples of the disclosure, the apparatus further includes:
a second priority determining module 2001, configured to determine, in response to the quality of service information including the second response time, a priority of sending the result information and other information to the first terminal according to the second response time.

FIG. 21 is a schematic block diagram of yet another relationship determination apparatus shown according to an example of the disclosure. As shown in FIG. 21, in some examples of the disclosure, the apparatus further includes:
a power determining module 2101, configured to determine, in response to the quality of service information including the distance upper limit, transmission power for sending the signal to the first terminal during determining the relative spatial relationship to the first terminal according to the distance upper limit; and
an information sending module 2102, configured to send the reference signal and/or the result information to the first terminal according to the transmission power.

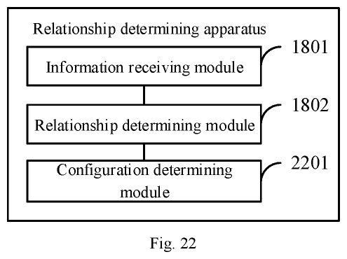

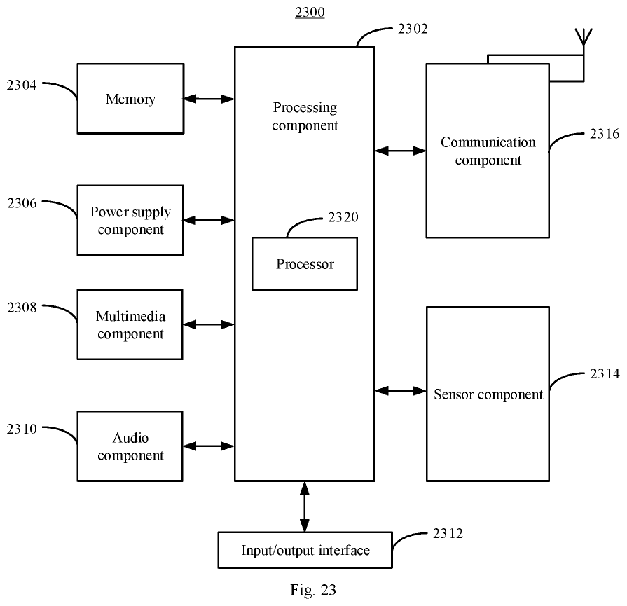

FIG. 22 is a schematic block diagram of yet another relationship determination apparatus shown according to an example of the disclosure. As shown in FIG. 22, in some examples of the disclosure, the apparatus further includes:
a configuration determining module 2201, configured to determine a configuration for sending a reference signal for determining the relative spatial relationship to the first terminal according to the configuration information sent by the first terminal.

In one example, the configuration information includes at least one of the followings:
bandwidth information, period information, time-domain density information, and frequency-domain density information.

In one example, the information receiving module is configured to receive the quality of service information sent by the first terminal during establishing a sidelink with the first terminal.

In one example, the information receiving module is configured to receive the quality of service information sent by the first terminal through a sidelink after establishing the sidelink with the first terminal.

As for the apparatus in the above examples, the specific modes for executing operations by all the modules have been described in the examples of the related method in detail, which will not be illustrated in detail here.

As for the apparatus examples, since the examples basically correspond to the method examples, relevant parts may refer to the partial illustration in the method examples. The apparatus examples described above are merely schematic. The modules described as separate parts may or may not be physically separated, and the parts displayed as modules may or may not be physical units, that is, the parts may be located in one place or distributed onto a plurality of network modules. Part or all of the modules can be selected according to actual needs to implement the objective of the solution of the present example. Those ordinarily skilled in the art may understand and implement the same without creative effort.

An example of the disclosure provides an electronic device, including:
a processor; and
a memory for storing executable instructions of the processor; where
the processor is configured to execute the information sending method described in any of the above examples, and/or the relationship determination method described in any of the above examples.

An example of the disclosure provides a computer-readable storage medium, storing a computer program instruction. The program instruction, when executed by a processor, implements the steps of the information sending method described in any of the above examples, and/or the relationship determination method described in any of the above examples.

FIG. 23 is a schematic block diagram of an apparatus 2300 for information sending and/or relationship determination shown according to an example of the disclosure. For example, the apparatus 2300 may be a mobile telephone, a computer, a digital broadcast terminal, a message transceiving device, a game console, a tablet device, a medical device, a fitness device, a personal digital assistant, and the like.

Referring to FIG. 23, the apparatus 2300 may include one or more of the following components: a processing component 2302, a memory 2304, a power supply component 2306, a multimedia component 2308, an audio component 2310, an input/output (I/O) interface 2312, a sensor component 2314, and a communication component 2316.

The processing component 2302 usually controls overall operation of the apparatus 2300, such as operations associated with displaying, telephone calling, data communication, a camera operation and a record operation. The processing component 2302 may include one or more processors 2320 to execute an instruction, so as to complete all or part of steps of the above method. In addition, the processing component 2302 may include one or more modules, so as to facilitate interaction between the processing component 2302 and other components. For example, the processing component 2302 may include a multimedia module, so as to facilitate interaction between the multimedia component 2308 and the processing component 2302.

The memory 2304 is configured to store various types of data so as to support operations on the apparatus 2300. Examples of these data include instructions of any application program or method used to be operated on the apparatus 2300, contact data, telephone directory data, messages, pictures, videos, and the like. The memory 2304 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 2306 provides electric power for various components of the apparatus 2300. The power supply component 2306 may include a power management system, one or more power sources, and other components associated with generating, managing and distributing electric power for the apparatus 2300.

The multimedia component 2308 includes a screen providing an output interface between the apparatus 2300 and a user. In some examples, the screen may include a liquid crystal display (LCD) and a touch panel (TP). In response to determining that the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 2308 includes a front camera and/or a back camera. In response to determining that the apparatus 2300 is in an operation mode, such as a shooting mode or a video mode, the front camera and/or the back camera may receive external multimedia data. Each front camera and each back camera may be a fixed optical lens system or have a focal length and optical zooming capability.

The audio component 2310 is configured to output and/or input an audio signal. For example, the audio component 2310 includes a microphone (MIC). When the apparatus 2300 is in an operation mode, such as a call mode, a recording mode or a speech recognition mode, the microphone is configured to receive an external audio signal. The received audio signal may be further stored in the memory 2304 or sent via the communication component 2316. In some examples, the audio component 2310 further includes a speaker for outputting the audio signal.

The I/O interface 2312 provides an interface between the processing component 2302 and a peripheral interface module, and the above peripheral interface module may be a keyboard, a click wheel, buttons, etc. These buttons may include but are not limited to: a home button, a volume button, a start button and a lock button.

The sensor component 2314 includes one or more sensors for providing state evaluations of all aspects for the apparatus 2300. For example, the sensor component 2314 may detect an on/off state of the apparatus 2300 and relative positioning of components. For example, the components are a display and a keypad of the apparatus 2300. The sensor component 2314 may further detect position change of the apparatus 2300 or one component of the apparatus 2300, whether there is contact between the user and the apparatus 2300, azimuth or speed up/speed down of the apparatus 2300, and temperature change of the apparatus 2300. The sensor component 2314 may include a proximity sensor, which is configured to detect existence of a nearby object without any physical contact. The sensor component 2314 may further include an optical sensor, such as a CMOS or CCD image sensor, for use in an imaging application. In some examples, the sensor component 2314 may further include an acceleration sensor, a gyroscope sensor, a magnetic sensor, a pressure sensor or a temperature sensor.

The communication component 2316 is configured to facilitate wired or wireless communication between the apparatus 2300 and other devices. The apparatus 2300 may access a wireless network based on a communication standard, such as WiFi, 2G or 3G, 4G LTE, 5G NR or their combination. In one example, the communication component 2316 receives a broadcast signal or broadcast related information from an external broadcast management system via a broadcast channel. In an example, the communication component 2316 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the apparatus 2300 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-temporary computer readable storage medium including instructions is further provided, such as a memory 2304 including instructions. The above instructions may be executed by a processor 2320 of the apparatus 2300 so as to complete the above method. For example, the non-temporary computer readable storage medium may be an ROM, a random access memory (RAM), a CD-ROM, a magnetic tape, a floppy disk, an optical data storage device and the like.

Those skilled in the art will easily figure out other implementation solutions of the disclosure after considering the specification and practicing the disclosure disclosed here. The disclosure intends to cover any transformation, usage or adaptive change of the disclosure, and these transformations, usages or adaptive changes conform to a general principle of the disclosure and include common general knowledge or conventional technical means in the technical field not disclosed by the disclosure. The specification and the examples are merely regarded as being example, and the true scope and spirit of the disclosure are indicated by the following claims.

It is to be understood that the disclosure is not limited to the exact structure that has been described above and shown in the accompanying drawings, and that various modifications and changes may be made without departing from the scope of the disclosure. The scope of the disclosure is limited merely by the appended claims.

It is to be noted that relational terms in the text such as “first” and “second” are used merely for distinguishing one entity or operation from another and do not necessarily require or imply any actual relationship or order between these entities or operations. The terms “including”, “containing”, or any other variations are intended to cover non-exclusive inclusion, such that a process, method, item or device that includes a series of elements not only includes those elements, but also other elements that are not explicitly listed, or further include elements inherent in such the process, method, item or device. Without further limitations, the elements limited by a statement “including one . . . ” do not exclude the existence of other identical elements in the process, method, item or device that includes the said elements.

The above provides a detailed introduction to the methods and apparatus provided by the examples of the disclosure. Specific examples are applied in the text to explain principles and implementations of the disclosure. The description of the above examples is merely used for helping understand the methods and core ideas of the disclosure. Meanwhile, for those ordinarily skilled in the art, there may be changes in specific implementations and application scope according to the ideas of the disclosure. To sum up, the content of this specification is not to be understood as a limitation on the disclosure.

In view of this, examples of the disclosure provide an information sending method, a relationship determination method, an information sending apparatus, a relationship determination apparatus, an electronic device and a computer-readable storage medium, so as to solve technical problems in the related art.

According to a first aspect of an example of the disclosure, an information sending method is provided, applicable to a first terminal, and including:
sending a quality of service information for determining the relative spatial relationship to a second terminal, the quality of service information is configured to determine the relative spatial relationship with the second terminal.

According to a second aspect of an example of the disclosure, a relationship determination method is provided, applicable to a second terminal, and including:
receiving quality of service information, sent by a first terminal, for determining a relative spatial relationship; and
determining the relative spatial relationship according to the quality of service information.

According to a third aspect of an example of the disclosure, an information sending apparatus is provided, applicable to a first terminal, and including:
an information sending module, configured to send a quality of service information for determining the relative spatial relationship to a second terminal, the quality of service information is configured to determine the relative spatial relationship with the second terminal.

According to a fourth aspect of an example of the disclosure, a relationship determination apparatus is provided, applicable to a second terminal, and including:
an information receiving module, configured to receive quality of service information, sent by a first terminal, for determining a relative spatial relationship; and
a relationship determining module, configured to determine the relative spatial relationship according to the quality of service information.

According to a fifth aspect of an example of the disclosure, an electronic device is provided, including:
a processor; and
a memory for storing executable instructions of the processor, where
the processor is configured to execute the above information sending method and/or the above relationship determination method. According to a sixth aspect of an example of the disclosure, a computer-readable storage medium is provided, storing a computer program instruction. The program instruction, when executed by a processor, implements the steps of the above information sending method and/or the above relationship determination method.

According to the examples of the disclosure, when needing to determine the relative spatial relationship to the second terminal, the first terminal may send the quality of service information for determining the relative spatial relationship to the second terminal. Accordingly, the second terminal may be caused to determine the relative spatial relationship with the first terminal according to the received quality of service information, such that the relative spatial relationship determined by the first terminal meets needed quality of service.

1. An information sending method, performed by a first terminal, and comprising:
sending a quality of service information for determining a relative spatial relationship to a second terminal, wherein the quality of service information is configured to determine the relative spatial relationship to the second terminal.

2. The information sending method according to claim 1, wherein the relative spatial relationship comprises at least one of the following:
a relative location, a relative distance or a relative angle.

3. The information sending method according to claim 1, wherein the quality of service information comprises at least one of the following:
precision information of the relative spatial relationship;
first response time for sending a reference signal for determining the relative spatial relationship to the first terminal;
second response time for sending a result information of the relative spatial relationship to the first terminal; or
a distance upper limit for determining the relative spatial relationship.

4. The information sending method according to claim 1, further comprising:
determining a service applied for determining the relative spatial relationship with the second terminal; and
determining the quality of service information according to the service.

5. The information sending method according to claim 1, further comprising:
sending configuration information to the second terminal, wherein the configuration information is configured to allow the second terminal to determine a configuration for sending a reference signal for determining the relative spatial relationship to the first terminal.

6. The information sending method according to claim 5, wherein the configuration information comprises at least one of the following:
bandwidth information, period information, time-domain density information, or frequency-domain density information.

7. The information sending method according to claim 5, further comprising:
determining a service applied for determining the relative spatial relationship with the second terminal; and
determining the configuration information according to the service.

8. The information sending method according to claim 1, wherein sending the quality of service information for determining the relative spatial relationship to the second terminal comprises at least one of the following:
sending the quality of service information to the second terminal during establishing a sidelink with the second terminal; or
sending the quality of service information to the second terminal through a sidelink after establishing the sidelink with the second terminal.

9. (canceled)

10. A relationship determination method, performed by a second terminal, and comprising:
receiving quality of service information, sent by a first terminal, for determining a relative spatial relationship; and
determining the relative spatial relationship according to the quality of service information.

11. The relationship determination method according to claim 10, wherein the relative spatial relationship comprises at least one of the following:
a relative location, a relative distance or a relative angle.

12. The relationship determination method according to claim 10, wherein the quality of service information comprises at least one of the following:
precision information of the relative spatial relationship;
first response time for sending a reference signal for determining the relative spatial relationship to the first terminal;
second response time for sending a result information of the relative spatial relationship to the first terminal; or
a distance upper limit for determining the relative spatial relationship;
the relationship determination method further comprising:
determining, in response to the quality of service information comprising the first response time, a priority of sending the reference signal and other information to the first terminal according to the first response time.

13. (canceled)

14. The relationship determination method according to claim 12, further comprising:
determining, in response to the quality of service information comprising the second response time, a priority of sending the result information and other information to the first terminal according to the second response time.

15. The relationship determination method according to claim 12, further comprising:
determining, in response to the quality of service information comprising the distance upper limit, transmission power for sending the signal to the first terminal during determining the relative spatial relationship with the first terminal according to the distance upper limit; and
sending at least one of the reference signal and the result information to the first terminal according to the transmission power.

16. The relationship determination method according to claim 10, further comprising:
determining a configuration for sending a reference signal for determining the relative spatial relationship to the first terminal according to configuration information sent by the first terminal.

17. The relationship determination method according to claim 16, wherein the configuration information comprises at least one of the following:
bandwidth information, period information, time-domain density information, or frequency-domain density information.

18. The relationship determination method according to claim 10, wherein receiving the quality of service information, sent by the first terminal, for determining the relative spatial relationship comprises at least one of the following:
receiving the quality of service information sent by the first terminal during establishing a sidelink with the first terminal; or
receiving the quality of service information sent by the first terminal through a sidelink after establishing the sidelink with the first terminal.

19. (canceled)

20. (canceled)

21. (canceled)

22. A terminal, comprising:
a processor; and
a memory for storing executable instructions, wherein
the processor, when executing the instructions, is configured to execute the following method:
sending a quality of service information for determining a relative spatial relationship to a second terminal, wherein the quality of service information is configured to determine the relative spatial relationship to the second terminal.

23. A non-transitory computer-readable storage medium storing a computer program, wherein the computer program, when executed by a processor, implements the information sending method according to claim 1.

24. A terminal, comprising:
a processor; and
a memory for storing executable instructions, wherein
the processor, when executing the instructions, is configured to execute the relationship determination method according to claim 10.

25. A non-transitory computer-readable storage medium storing a computer program, wherein the computer program, when executed by a processor, implements the relationship determination method according to claim 10.
